(19) United States
(12) Patent Application Publication
(10) Pub. No.: US 2008/0008866 A1
(43) Pub. Date: Jan. 10, 2008

(54) Silicone modified polyurea

(75) Inventor: Stuart B. Smith, Loganville, GA (US)

Correspondence Address: PATTON BOGGS, L.L.P., 2001 ROSS AVENUE, SUITE 3000, DALLAS, TX, 75201, US

(73) Assignee: ReactAmine Technology, LLC

(21) Appl. No.: 11/650,879

(22) Filed: Jan. 8, 2007

Related U.S. Application Data
(63) Continuation-in-part of application No. 10/400,956, filed on Mar. 27, 2003, now Pat. No. 6,946,880.
(63) Continuation-in-part of application No. 10/839,889, filed on May 5, 2004.
Application No. 10/839,889 is a continuation-in-part of application No. 10/648,934, filed on Aug. 27, 2003.
(60) Provisional application No. 60/408,797, filed on Sep. 9, 2002.
(60) Provisional application No. 60/412,211, filed on Sep. 23, 2002.

(51) Int. Cl. C08G 18/10; B32B 27/06

(52) U.S. Cl. 428/220; 525/452; 528/67

(57) ABSTRACT

The present invention includes a novel polyol prepolymer including an aliphatic amine, aromatic amine, or a mixture of both aliphatic and aromatic amines with an epoxy functional silicone to produce the novel polyol prepolymer chain extender. In another aspect of the invention, the novel polyol prepolymer chain extender is reacted with a polyisocyanate to produce a novel silicone modified polyurea having improved adhesion, chemical resistance, UV stability, and decreased shrinkage properties.

### CROSS REFERENCES TO RELATED APPLICATIONS

This application is a continuation-in-part of application Ser. No. 11/400,956, filed 10 Apr. 2006 and a continuation-in-part of application Ser. No. 10/839,889, filed 05 May 2004, both of which are a continuation-in-part of application Ser. No. 10/648,934, filed 27 Aug. 2003, which claims the benefit of U.S. Provisional Application No. 60/408,797, filed 09 Sep. 2002 and U.S. Provisional Application No. 60/412,211, filed 23 Sep. 2002.

### FIELD OF THE INVENTION

The present invention relates to synthetic resins and processes for making the same and more particularly, relates to methods and compositions for making aliphatic and aromatic two part polyurea elastomers having improved adhesion, chemical resistance, UV stability, and decreased shrinkage properties.

Problem

Polyurea's are defined as amine terminated polyols reacted with polyisocyanates. Polyureas were developed in the 1980's for rapid process application of a durable protective membranes for a myriad of products and technologies. Conventional polyurea coatings typically possess several characteristics that have made them desirable as a seamless membrane including fast, consistent reactivity and cure, moisture and temperature insensitivity during application, exceptional elastomeric quality, hydrolytically stable (i.e. low water absorption), high thermal stability, and that they are auto catalytic and do not emit solvents or VOCs when applied However, many characteristics of conventional polyureas are unfavorable and limit their use in many applications.

The conventional aromatic polyurea uses mixtures of aromatic diamines such as diethyltoluenediamine and polyether amines reacted with an methylene diphenyl isocyanate (MDI) prepolymer with optional levels of propylene carbonate added. This material reacts in 5 seconds to produce a polyurea. A conventional aliphatic polyurea can be made with aliphatic isocyanate reacted with aliphatic amines, such as Jefferamine T-403, D400, D2000, or NH 1220 from Huntsman and NH 1420 from Bayer. This reaction is very fast with gel times of 5 seconds. Both the conventional aromatic and aliphatic polyureas are attacked by strong solvents such as xylene, toluene, acetone, low pH acids, and high pH caustics.

Another undesirable characteristics of conventional polyureas is that conventional polyureas possess poor adhesion properties. Specifically, the fast reaction times inherent in conventional polkas cut short the time needed for a conventional polyurea to penetrate and adhere to its substrate. Commercial epoxy type resins have been used in place of conventional polyureas because they are slow to react but penetrate to give excellent adhesion and chemical resistance.

Yet another problem of conventional polyureas and epoxies is that they do not possess good color stability or UV resistance. Aromatic polyureas, due to their aromatic reactants, generally turn yellow or brown when exposed to ultraviolet (UV) light and oxygen. Since polyureas can be formulated in a variety of colors, this discoloration trait adversely affects the intended finish color of the conventional polyurea, especially in light colors.

Also, conventional polyureas shrink about 1%-1.5% when they cure, which means, for example, when 1,000 linear feet of polyurea is applied to a roofing project, once it cures, some 10 to 15 feet of polyurea will shrink and need to be reapplied

Another problem of conventional polyureas is that when mixing them for the first time, such as using an impingement gun, a first reaction takes place between those highly reactive ingredients followed by later subsequent reactions between the less reactive reactants. This causes non-homogenous minutes in the polyurea with the end result being a polyurea with varying finishes, properties, and consistency. Other factors that can lead to these non-homogenous mixtures is the temperature of the reactants as they are mixed. These non-homogenous mixtures can occur in one order with the reactants at a certain temperature and another order at another temperature.

To work around some of the problems, silicone epoxy products have been used in place of conventional polyureas due to their superior chemical resistance and low surface tension, which better wets the surface of substrates to improve adhesion, however these silicone epoxy products are very slow to react. Silicones have also been used in place of conventional polyureas because of their outstanding weatherability, color stability, and UV resistance. In addition, conventional polyureas and epoxies have more porous surfaces compared to silicones and this causes poor graffiti resistance compared to silicones. Although epoxies possess good chemical resistance, they are slow to cure and are brittle thereby limiting their usefulness in applications. It is well known that silicones impart mar resistance.

In an effort to improve chemical resistance and adhesion properties in conventional polyureas, epoxies have been reacted with amines and isocyanates. However, epoxy modified polyureas are very difficult to maintain viscosity or molecular weight. For example, the typical bis A epoxy when reacted with primary and secondary amines forms amino alcohols. The OH groups on the amino alcohols reacts with the isocyanate to produce a polyurethane, which is not a polyurea and which further acts as a cross linker and not a chain extender. These amino alcohols, given time, will set up and be rather useless in any commercial sense.

Information relevant to attempts to address these problems can be found in the U.S. Pat. No. 5,731,397 issued 24 Mar. 1998 to Primeaux and U.S. Pat. No. 5,962,618 issued 05 Oct. 1999 to Primeaux.

Therefore, there is a need for a polyurea with a silicone backbone that would increase chemical resistance, UV stability, adhesion, and decreased shrinkage properties. Furthermore, there is a need for polyurea that is not susceptible to non-homogeneous mixtures that provide polyureas in different consistencies and properties.

Solution

The above described problems are solved and a technical advance achieved in the art by a polyol prepolymer chain extender with aliphatic epoxy end groups that can react with either an aromatic amine, an aliphatic amine, or a combination of both aromatic and aliphatic amines. In addition, the polyol prepolymer chain extender is then mixed with other B-component reactants prior to reacting with the A-component polyisocyanates to form silicone modified polyurea, which significantly improves the characteristic of the polyurea with the formation of de minimis amounts of amino alcohols or polyurethanes.

The polyol prepolymer chain extender can be either aromatic, aliphatic, or both. The polyol prepolymer chain extender is preferably prepared prior to mixing with other B-component ingredients. By reacting an epoxy silicone with a primary amine, a polyurea is produced which includes a silicone backbone for improved properties.

In addition, the present polyol prepolymer chain extender includes a secondary polyether amine reacted with a monomer stripped aliphatic isocyanate dimmer to produce prepolymers with about 5% to about 18% isocyanate content. Further, for improved viscosity and UV stability, the present polyol prepolymer chain extender includes a diluent such as caprolactone.

Thus, the present polyol prepolymer chain extenders and silicone modified polyureas provides improved chemical resistance, UV and color stability, adhesion, and decreased shrinkage to meet the requirements of the user.

### BRIEF DESCRIPTION OF THE DRAWINGS

FIG. 1 illustrates a side view of an embodiment of the present silicone modified polyurea for use as a ballistic resistant panel;

FIG. 2 illustrates a side view of another embodiment of the present silicone modified polyurea for use as a ballistic resistant panel;

FIG. 3 illustrates a top view of the embodiment of the present silicone modified polyurea of FIG. 2;

FIG. 4 illustrates a perspective view of an embodiment of a rod-shaped material used in the embodiments of the present silicone modified polyurea of FIGS. 1-3;

FIG. 5 illustrates additional cross-sections of embodiments of a md-shaped material used in the embodiments of the present silicone modified polyurea of FIGS. 1-3; and

FIG. 6 illustrates a flow diagram of an embodiment of a process for making a ballistic resistant panel with an embodiment of the present silicone modified polyurea.

### DETAILED DESCRIPTION OF THE INVENTION

Polyureas typically have A-component reactants and B-component reactants that are kept in separate containers or vessels, due to their reactivity, and are mixed just prior to being applied to a substrate. Conventionally, the A-component reactants include a polyisocyanate and the B-component reactants include an amine terminated polyol.

The present invention B-component reactants include a novel polyol prepolymer chain extender that includes at least one amine reacted with an epoxy functional silicone. In one aspect of the present invention, the polyol prepolymer chain extender includes a silicone that has an epoxy end group which reacts with an aromatic or aliphatic amine or combination of aromatic and aliphatic amines to produce the novel polyol prepolymer chain extender. In one aspect of the present invention, the epoxy end group on the silicone is aliphatic and more preferably is glycidyl ether. The aliphatic epoxy end group provides increased UV and color stability of the silicone modified polyurea. Exemplary epoxy functional silicones include 2810 from OSI Specialties and SILRES® HP 1000 from Wacker Chemicals Corp. Both products have Hydrogen equivalent weights of 300-400. One non-limiting example of an epoxy functional silicone is shown in formula (I): 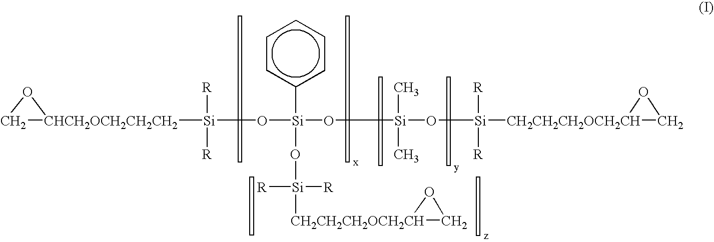
wherein x is an integer from about 1 to about 20, y is an integer from about 1 to about 20, and z is an integer from about 1 to about 20.

The amines of the B-component polyol prepolymer chain extender preferably include primary and secondary amines reacted with the epoxy functional silicone. In one aspect of the polyol prepolymer chain extender, the aliphatic primary amines are low molecular weight amines, such as D230, D400, or T403 from Huntsman, polyaspartic amines, such as NH 1220 and NH 1420 from Bayer, and dimethylthiotoluenediamine (DMTDA), 3,5-dimethylthio-2,6-toluenediamine or 3,5-dimethylthio-2,4-toluenediamine, such as E-300 from Albemarle Corporation. In addition, aromatic amines may be used in the polyol prepolymer chain extender, such as diethyltoluenediamine (DETDA) E-100 Ethacure from Albemarle Corporation. In one aspect of the present polyol prepolymer chain extender, these amines are used in combination with one another or separately, when reacted with an epoxy functional silicone. The gel and tack free time for the two component silicone modified polyurea can be adjusted by using different combinations and amounts of these amines with the epoxy functional silicone during the preparation of the polyol prepolymer chain extender. For example to produce a silicone modified poppa with fast gel and tack free time, a polyol prepolymer chain extender is prepared including D400 and E-100 which is reacted with an epoxy functional silicone prior to mixing with the polyisocyanate. Conversely, for slower gel and tack free time, a polyol prepolymer chain extender is prepared including NH1220 and D400 which is reacted with an epoxy functional silicone. Some non-liming examples of the aliphatic primary amines are shown in formulas (II), (III), and (IV):

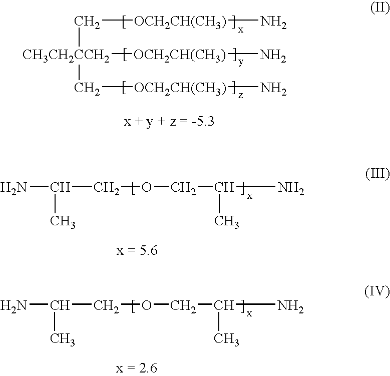

The following chart shows the hydrogen equivalent weights of some these non-limiting aliphatic primary amines.

| Product | Equivalent/gm |
|---|---|
| T-403 | 80 |
| D-400 | 230 |
| D-230 | 60 |

In addition to the novel polyol prepolymer chain extender herein described, the B-component of the present silicone modified polyurea also preferably includes high molecular weight amine-terminated polyethers or simply polyether amines. The term “high molecular weight” is intended to include polyether amines having a molecular weight of at least about 2000. Particularly preferred are the JEFFAMINE® series of polyether amines available from huntsman Corporation; they include JEFFAMINE D-2000, JEFFAMINE D4000, JEFFAMINE T-3000 and JEFFAMINE T-5000.

In addition, the B-component of the silicone modified polyurea also preferably includes addition amounts of curative amines, such as E-100 Ethacure from Albermarle. Also preferably, aromatic diamines, such as Unilink 4200 from UOP, which is a secondary amines, are added to the B-component to help control the cross-linking and reactivity of the silicone modified polyurea.

In addition, the B-component preferably includes at least one coupling agent, such as A1100. The coupling agent is typically a silane with amine on the end of it so it become reactive as part of the structure. Other coupling agents that can be used are glycidylether silane, such as A-187 from OSi Specialties, Inc., which is a polyglyceride.

Also, pigments, for example titanium dioxide, may be incorporated in the B-component, to impart color properties to the silicone modified polyurea. Typically, such pigments are added with the in the B-component prior to mixing with the A-component. A non-limiting example of a titanium dioxide pigment is Ti-Pure® R-900 utile titanium dioxide from E.I. Pont de Nemours C.

In addition, UV stabilizer materials are also preferably mixed with the B-components, to impart better UV resistance to the silicone modified polyurea. Some non-limiting examples of UV stabilizers are Tinuvin® 328 and Tinuvin® 765 from Ciba-Geigy Corp.

The aliphatic and/or aromatic silicone modified polyurea of the present invention typically includes an A-component, such as an isocyanate, which may be an aliphatic or aromatic isocyanate. The aliphatic isocyanates are known to those in the art. For instance, the aliphatic isocyanates may be of the type described in U.S. Pat. No. 4,748,192, incorporated by reference herein. Accordingly, they are typically aliphatic diisocyanates, and more particularly are the tri zed or the biuretic form of an aliphatic diisocyanate, such as, hexamethylene diisocyanate (HMDI); or the bifunctional monomer of the tetraalkl xylene diisocyanate, such as tetramethyl xylene diisocyanate (TMXDI). Cyclohexane diisocyanate is also to be considered a preferred aliphatic isocyanate. Other useful aliphatic polyisocynates are described in U.S. Pat. No. 4,705,814, also incorporated by reference herein. They include aliphatic diisocyanate, for example, alkylene diisocyanate with 4 to 12 carbon atoms in the alkylene radical, such as 1,12-dodecane diisocyanate and 1,4-tetramethylene diisocyanate. Also described are cycloaliphatic diisocyanates, such as 1,3- and 1,4-cyclohexane diisocyanate as well as any desired mixture of these isomers; 1-isocyanato-3,3,5-trimethyl-5-isocyanatomethylcyclohexane (isophorone diisocyanate); 4,4′-, 2,2′- and 2,4′-dicyclohexylmethane diisocyanate, as well as the corresponding isomer mixtures, and the like. Exemplary isocyanate monomers include monoisocyanate compound (pa=) such as m- or p-isopropenyl-α,α dimethylbenzoyl isocyanate.

Aromatic isocyanates may also be employed. Suitable aromatic polyisocyanates include, but are not necessarily limited to m-phenylene diisocyanate; p-phenylene diisocyanate; polymethylene polyphenylene diisocyanate; 2,4-toluene diisocyanate; 2-6 toluene diisocyanate; dianisidine diisocyanate, bitolylene diisocyanate; naphthalene-1,4-diisocyanate; diphenylene 4,4′-diisocyanate and the like. Suitable aliphatic/aromatic diisocyantes, include, but are not necessarily limited to xylylene-1,3-diisocyanate, bis(4-isocyanatopheny)methane; bis(3-methyl-4-isocyanatophenyl)methane; and 4,4′-diphenylpropane diisocyanate. The aforestated isocyanates can be used alone or in the combination. In one embodiment of the invention, aromatic isocyanates are preferred.

The isocyanate compound used in the present invention has a structure wherein all of the isocyanate (NCO) groups in the molecule have secondary or tertiary carbon bonded thereto. The groups other than the NCO group bonding to the secondary or the tertiary carbon are not limited, for example, in terms of the number of carbon atoms, bulkiness, inclusion of hereto atoms such as O, S, and N, and the like. The two groups bonding to the tertiary carbon may be either the same or different from each other.

When producing a polyol prepolymer chain extender or an isocyanate prepolymer, it is necessary have to have an adduct or excess amount of amine to keep the reactants liquid. This also means that the adduct or excess of amine reacts with the isocyanate prepolymer when making the final silicone modified polyurea. This requires carefully adjusting of the amine level so that the speed of reactivity and conversion are controlled. Therefore, when mixing an A-component and a B-component together, it is preferable to include 105% stoichiometrically of the A-component compared to the B-component. This means a 5% stoichimetric excess of polyisocyanates are preferably used in the mixtures. This is done because any excess isocyanate will moisture cure.

This careful attention to the amine adduct is also important during application to a substrate, such as spraying. The viscosity of the mix at the tip of the application device, such as an impingement gun, is very important, because if the viscosity is too high then the internal mix where the A-component reactants and the B-component reactants is inadequate for a consistent silicone modified polyurea. Furthermore, if the viscosity is too high, then additional heat may be required to raise the temperatures of the reactants to bring the viscosity down low enough to spray.

Three non-limiting examples of the novel polyol prepolymer chain extender are shown in formulas (V), (VI), and (VII): 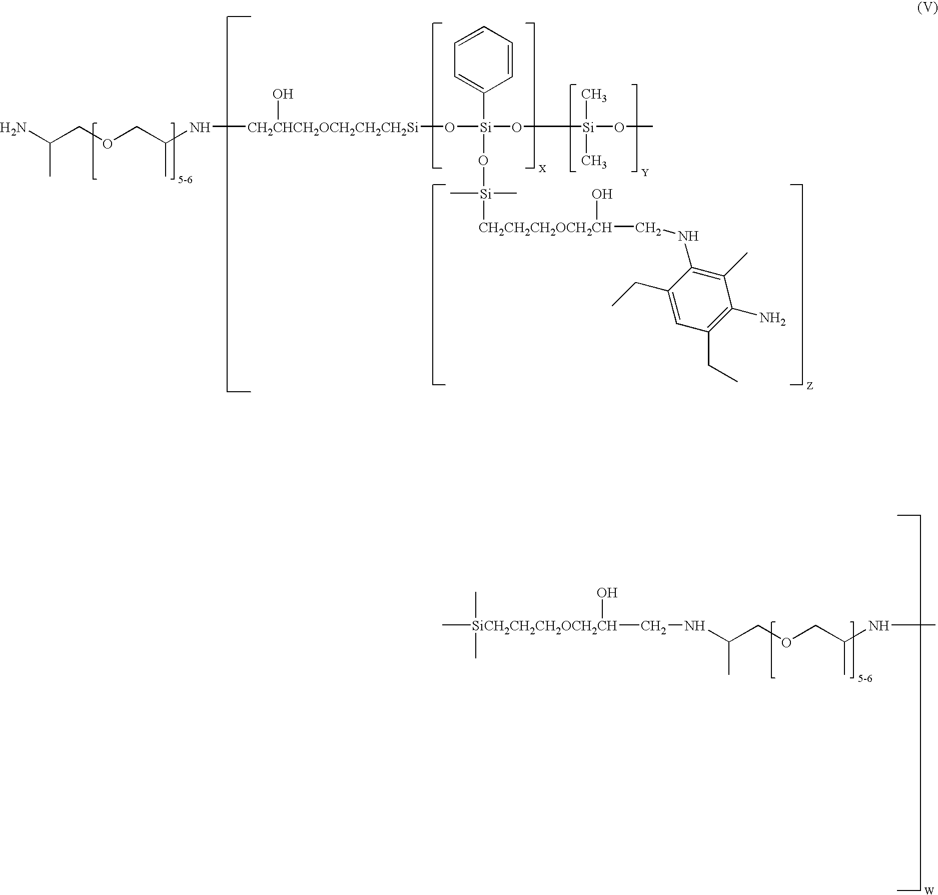 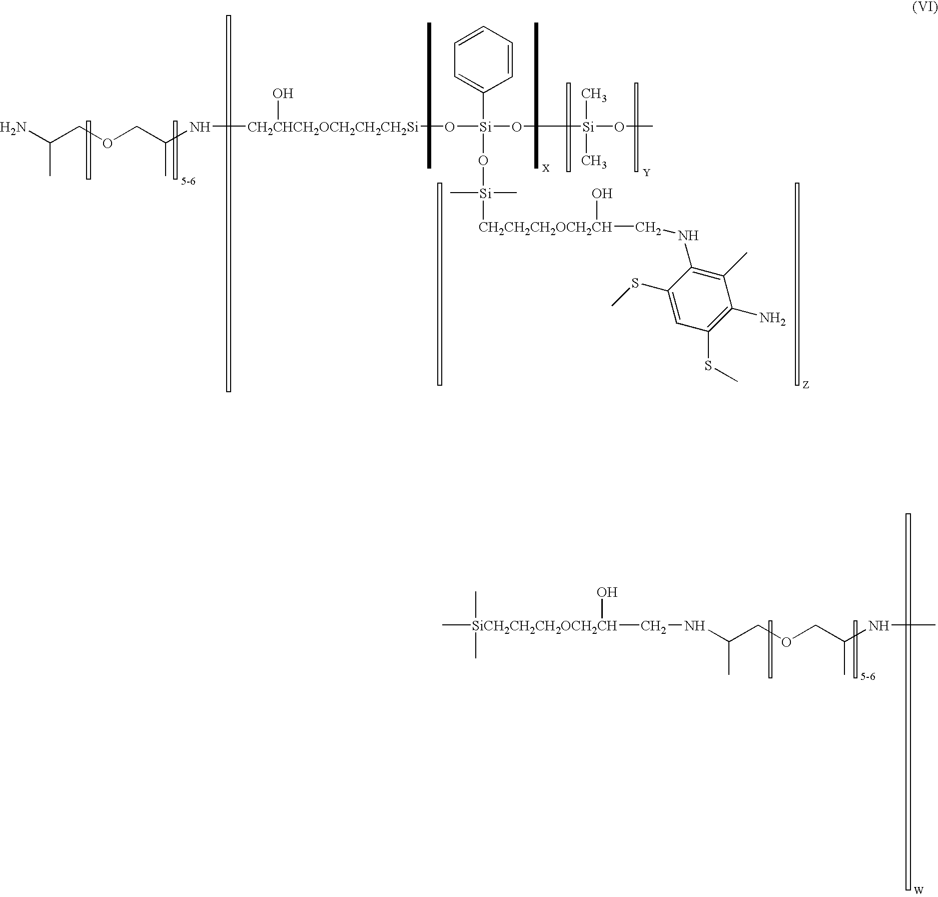 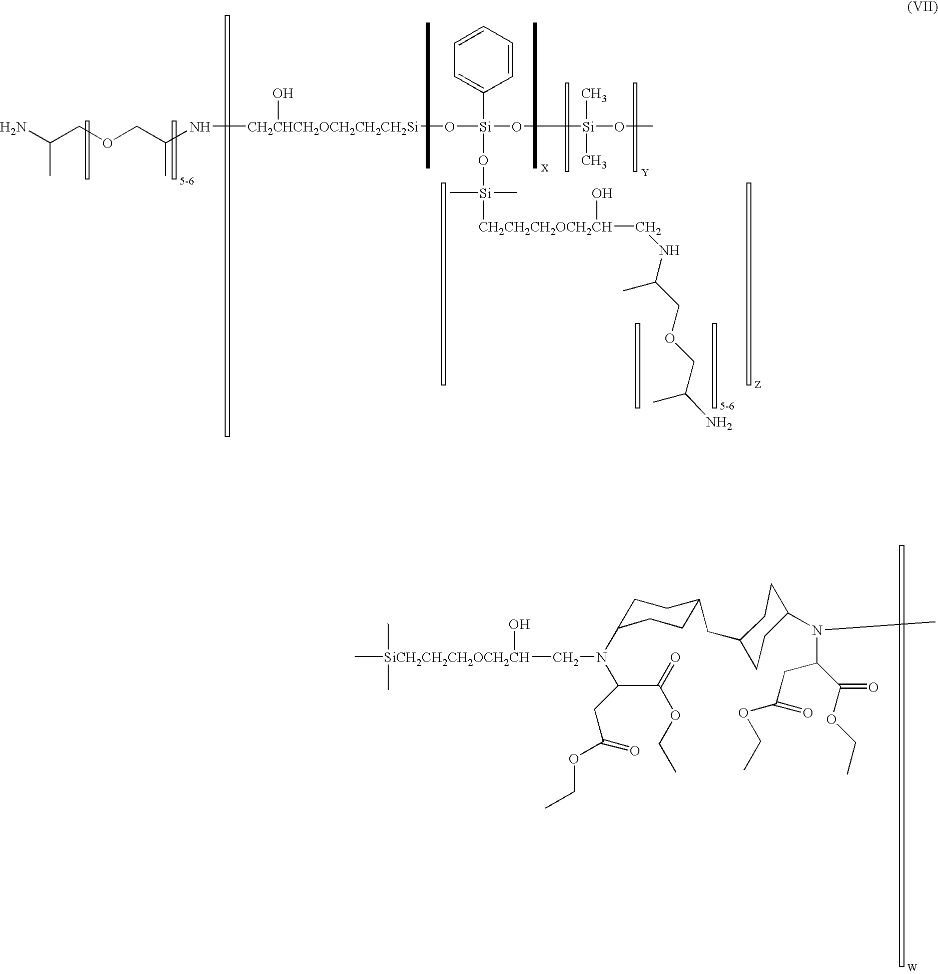
where the values of W, X, Y, and Z in formulas (V), (VI, and (VII) are as follows. The value for X is a number greater than or equal to 1, and preferably X is in the range of from 1 to 10, and more preferably, X is equal to 1. The value for Z is a number greater than or equal to 1. The value for Y is a number greater than or equal to 1, and preferably Y is in the range or from 10-200, and more preferably Y is equal to 15. The value for W is a number greater than or equal to 1.

Two non-limiting examples of the novel silicone modified polyurea are shown in formulas (VIII) and (IX): 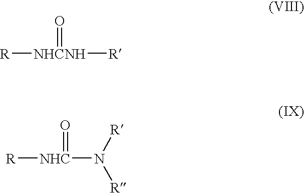
where R, R′, and R″ groups are the novel polyol prepolymer chain extenders described herein.

The following examples are provided to further illustrate the preferred embodiments of the present invention polyol prepolymer chain extender, but should not be construed as limiting the invention in anyway. Compositions of the polyol prepolymer chain extender were produced by mixing amines with an epoxy functional silicone polymer shown in Examples 1-7. The following amines were reacted with the following silicone polymers noted in Table 1.

TABLE 1

| | Examples | | | | | | |
|---|---|---|---|---|---|---|---|
| | 1 | 2 | 3 | 4 | 5 | 6 | 7 |
| T-403 | 300 | — | — | — | — | — | — |
| 2810 or HP1000 | 100 | 100 | 100 | 100 | 100 | 100 | 100 |
| D400 | — | 300 | 300 | — | — | 300 | 300 |
| E-100 | — | — | 500 | — | 500 | — | — |
| D230 | — | — | — | 300 | 300 | — | — |
| E-300 | — | — | — | — | — | 500 | — |
| NH1220 | — | — | — | — | — | — | 400 |

All amounts of the compounds in Table 1 are represented by parts by weight The reactions between the amines and the epoxy functional silicone polymer are slow and produce a low exotherm. In one aspect of the present invention, to increase reaction times of these reactants in Examples 1-7, the reactants are heated to a minimum temperature from 130° F. to 210° F., preferably 180° F., for two hours with an excess of amine to keep the product liquid, as provided in the Table 1. In another aspect of the present invention, the heating periods are between 30 minutes to 24 hours. In one aspect of the present invention the polyol prepolymer chain extender was allowed to cool prior to mixing with other reactants, described herein, in the B-component formula. In another aspect of the present invention, all reactants of the B-component formula, described herein, are mixed together and heated from 130° F. to 210° F., preferably 180° F., for a minimum of 30 minutes. The excess amount of amine can be adjusted to suit the purpose of a specific application. It is understood that increased amounts of silicone are better for polyurea performance. The polyisocyanate is preferably prepared using a 2000 molecular weight (mwt) silicone diol reacted with an isocyanate to form a polyurea prepolymer with better chemical and UV resistance when its product is reacted to the silicone modified polyol side. Silicone 2812 from OSI is a 2000 mwt diol with 1000 eq. Wt.

Examples of the prepolymer are as follows in Examples 8-9.

### EXAMPLE 8

A 22% NCO aliphatic dimer such as N-3400 (Bayer) is reacted with 2812 (OSI) silicone at a ratio of:

| 80 PBW | N3400 |
|---|---|
| 20 PBW | 2812 |

All amounts are represented by parts by weight. This product is heated at 150° F. for two hours. The results are an 18% NCO polyurea prepolymer with silicone in the backbone.

### EXAMPLE 9

A 29% NCO aromatic urethane isocyanate, ICI Huntsman 1680, is reacted with 2812 silicone at a ratio of:

| | |
|---|---|
| 60 PBW | 1680 |
| 40 PBW | 2812 |

All amounts are represented by parts by weight. This product was heated at 180° F. for two hours. The result is a 16% NCO polyurea prepolymer with silicone in the backbone. Examples of silicone modified polyureas are given below in Examples 10-15.

### EXAMPLE 10

### Aliphatic Silicone Polyurea

An aliphatic silicone modified polyurea was prepared with 15 PBW T-403/2810 adduct (Example 1), 75 PBW NH1220 (Bayer) polyaspartic ester, 10 PBW pigment white (TiO₂), 1 PBW T-292 UV stabilizer, and 0.8 PBW A1100 silicone coupling agent. This constitutes the B-component of the aliphatic silicone modified polyurea. This was mixed to 110 PBW of polyurea prepolymer of Example 8. This aliphatic silicone modified polyurea has a gel time of about 45 seconds when spray applied by a Gusmer H2035 spray machine. The product was spray applied to a concrete and meal panel and checked for adhesion and placed in a weathermeter for UV stability.

### EXAMPLE 11

### Another Aliphatic Polyurea Without Silicone

An aliphatic modified polyurea was prepared with 15 PBW T-403, 75 PBW NH1220 (Bayer) polyaspartic ester, 10 PBW pigment white (TiO₂), 1 PBW T-292 UV stabilizer, and 18 PBW A1100 silane coupling agent. This constitutes the B-component of the aliphatic modified polyurea. This was mixed to 110 PBW of polyurea prepolymer consisting of N3400 and D2000 Jeffamines mixed to 18% NCO. This aliphatic modified polyurea has a gel time of approximately 15 seconds when spray applied by a Gusmer H2035 spray machine. The product was spray applied to a concrete and metal panel and checked for adhesion and placed in a weathermeter for UV stability.

### EXAMPLE 12

### Aromatic Polyurea

An aromatic silicone modified polyurea was prepared with 15 PBW E-100 diethyltolueneimine (DETDA), 10 PBW D400, and 75 PBW D2000. This constitutes the B-component of the aromatic silicone modified polyurea. This was mixed to 110 PBW of polyurea prepolymer consisting of a Huntsman 9484 prepolymer MDI with 16% NCO. This aromatic silicone modified polyurea has a gel time of approximately 5 seconds when spray applied by a Gusmer H2035 spray machine. The product was spray applied to a concrete and metal panel and checked for adhesion and placed in a weathermeter for UV stability.

### EXAMPLE 13

### Another Aromatic Polyurea

An aromatic silicone modified polyurea was prepared with 25 PBW D400/2810/E-100 (Example 3), 75 PBW D2000. This constitutes the B-component of the aromatic silicone modified polyurea. This was mixed to 110 PBW of polyurea prepolymer consisting of a Huntsman 9484 prepolymer MDI with 16% NCO. This has a gel time of approximately 10 seconds when spray applied by a Gusmer H2035 spray machine. The product was spray applied to a concrete and metal panel and checked for adhesion and placed in a weathermeter for UV stability.

### EXAMPLE 14

### Another Aromatic Polyurea with Silicone

An aromatic silicone modified polyurea with silicone was prepared with 15 PBW E-100 diethyltoluenediamine (DETDA), 10 PBWD400/2810 adduct (Example 2), and 75 PBWD2000. This constitutes the B-component of the aromatic silicone polyurea. This was mixed to 110 PBW of polyurea prepolymer of 29% NCO aromatic urethane isocyanate (Example 9). This aromatic silicone modified polyurea has a gel time of approximately 8 seconds when spray applied by a Gusmer H2035 spray machine. The product was spray applied to a concrete and metal panel and checked for adhesion and placed in a weathermeter for UV stability.

### EXAMPLE 15

### Another Aromatic Polyurea with Silicone

An aromatic silicone modified polyurea with silicone was prepared with 25 PBW E-100/D400/HP1000 (Example 3), 75 PBW D2000. This constitutes the B-component of the aromatic silicone modified polyurea. This was mixed to 110 PBW of polyurea prepolymer of 29% NCO aromatic urethane isocyanate (Example 9). This aromatic silicone modified polyurea has a gel time of approximately 12 seconds when spray applied by a Gusmer H2035 spray machine. The product was spray applied to a concrete and metal panel and checked for adhesion and placed in a weathermeter for UV stability.

The compositions of Examples 10-15 were evaluated and are shown in Table 2.

TABLE 2
Adhesion PSI

| Examples | Concrete | Steel | UV Results in 1000 Hrs |
|---|---|---|---|
| 10 | 400 | 1200 | Excellent |
| 11 | 309 | 1000 | Slight Yellow |
| 12 | 350 | 1250 | Yellow/Brownish |
| 13 | 400 | 1275 | Yellow |
| 14 | 450 | 1375 | Slight Yellow |
| 15 | 475 | 1400 | Very Slight Yellow |

The above UV results were achieved by using a B-bulb on a QUV machine. Also the adhesion results were performed using ASTM #4551 elcometer. The adducts in which E-100, silicone, and polyether amine that were pre-heated show better adhesion and UV resistance then when E-100 is added without being reacted

The compositions of Examples 10-15 were evaluated for chemical resistance and are shown in Table 3.

TABLE 3

| | | | | | H₂SO₄ | HCl | H₂PO₄ | |
|---|---|---|---|---|---|---|---|---|
| Examples | Xylene | Toluene | Acetone | MEK | (50%) | (50%) | (50%) | Caustic |
| 10 | R | R | R | R | R | R | R | R |
| 11 | RC | RC | RC | NR | NR | NR | NR | NR |
| 12 | RC | RC | RC | NR | NR | NR | NR | NR |
| 13 | RC | RC | RC | NR | NR | NR | NR | NR |
| 14 | R | R | R | R | R | R | R | R |
| 15 | R | R | R | R | R | R | R | R |

All samples in Table 3 were placed in a glass cover for 48 hours with the chemical on the surface of the sample. R=Recommended, RC=Recommended conditional, NR=Not recommended

Additional examples of silicone modified polyureas are given below. Comparative examples 16-18 are conventional ratios and compositions and do not include any polyol prepolymer. Examples 19-20 are examples of the present silicone modified polyurea and do include amounts of different combinations and ratios of the novel polyol prepolymer chain extenders. All amounts are represented by parts by weight.

### Comparative Examples 16-17 and Examples 18-20

TABLE 4

| | Examples | | | | |
|---|---|---|---|---|---|
| | 16 | 17 | 18 | 19 | 20 |
| Polyol prepolymer chain | — | — | — | — | 25 |
| extender of Example 3 | | | | | |
| D2000 (Jeffamine) | 50 | 50 | 45 | 45 | 45 |
| T-5000 (Jeffamine) | 10 | 10 | 10 | — | — |
| Polyol prepolymer chain | — | — | — | 10 | 10 |
| extender of Example 7 | | | | | |
| E100 (Ethacure) | 25 | 15 | 15 | 15 | — |
| 4200 (Unilink) | — | 10 | — | — | — |
| A-187 | 0.4 | 0.4 | 0.4 | 0.4 | 0.4 |
| 15.5% NCO Index | 105 | 105 | 105 | 105 | 105 |
| Gel Time (Sec) | 3.5 | 4.8 | 5.0 | 4.5 | 4.5 |
| Tack Free (Sec) | 5.5 | 7.5 | 7.5 | 6.5 | 7.5 |

### Physical Property Testing

Physical property testing for the silicone modified polyureas noted in Table 4 were done in accordance wit American Society for Testing and Materials (ASTM). The ASTM test methods and their physical property test descriptions are given below in Table 5:

TABLE 5

| | Examples | | | | |
|---|---|---|---|---|---|
| | 16 | 17 | 18 | 19 | 20 |
| Tensile Strength PSI | 2541 | 2430 | 2516 | 3350 | 3620 |
| ASTM D-638 | | | | | |
| % Elongation | 235 | 265 | 410 | 340 | 300 |
| ASTM D-638 | | | | | |
| Tear Strength P.L.I. | 357 | 340 | 500 | 525 | 610 |
| ASTM D-624 | | | | | |
| Shore Hardness D | 47/40 | 47/40 | 47/40 | 47/40 | 50/45 |
| ASTM D2240-81 | | | | | |
| Abrasion HS-18 Wheel | 0.6 | 0.6 | 0.4 | 0.4 | 0.4 |
| (mg) 1000 gm-1000 | | | | | |
| cycle loss ASTM D-4060 | | | | | |
| Elcometer PSI | — | — | — | — | — |
| Concrete | 450 | 375 | 750 | 900 | 950 |
| Steel | >1000 | >1000 | >1300 | >1500 | >1500 |
| ASTM 4551 | | | | | |
| Moisture Vapor | <0.1 | <0.1 | <0.1 | <0.1 | <0.1 |
| Transmission (Perms) | | | | | |
| ASTM E96-80 | | | | | |
| Water Absorption (%) | 1.90 | 2.20 | 1.25 | 0.85 | 0.85 |
| WT Gain | | | | | |
| ASTM D570-95 | | | | | |

Additional examples of silicone modified polyureas are given below. Comparative examples 21-22 are conventional ratios and compositions and do not include any polyol prepolymer. Examples 23-24 are examples of the present silicone modified polyurea and do include amounts of different combinations and ratios of the novel polyol prepolymer chain extenders. All amounts are represented by parts by weight.

### Comparative Examples 21-22 and Examples 23-24

TABLE 6

Examples

| | 21 | 22 | 23 | 24 |
|---|---|---|---|---|
| D2000 (Jeffamine) | 50 | 50 | 45 | 45 |
| T-5000 (Jeffamine) | 10 | 10 | 10 | — |
| Polyol prepolymer chain | — | — | 10 | — |
| extender of Example 7 | | | | |
| Polyol prepolymer chain | — | — | — | 25 |
| extender of Example 6 | | | | |
| E100 (Ethacure) | 25 | 15 | 15 | — |
| 4200 (Unilink) | — | 10 | — | — |
| A-187 | 0.4 | 0.4 | 0.4 | 0.4 |
| 15.5% NCO Index | 105 | 105 | 105 | 105 |
| Gel Time (Sec) | 3.5 | 4.8 | 5.0 | 35.0 |
| Tack Free (Sec) | 5.5 | 7.5 | 7.5 | 50.0 |

### Physical Property Testing

Physical property testing for the silicone modified polyureas noted in Table 6 were done in accordance with American Society for Testing and Materials (ASTM). The ASTM test methods and their physical property test descriptions are given below in Table 7:

TABLE 7

| | Examples | | | |
|---|---|---|---|---|
| | 21 | 22 | 23 | 24 |
| Tensile Strength PSI | 2541 | 2430 | 2516 | 3350 |
| ASTM D-638 | | | | |
| % Elongation | 235 | 265 | 410 | 340 |
| ASTM D-638 | | | | |
| Tear Strength P.L.I. | 357 | 340 | 500 | 525 |
| ASTM D-624 | | | | |
| Shore Hardness D | 47/40 | 47/40 | 47/40 | 47/40 |
| ASTM D2240-81 | | | | |
| Abrasion HS-18 Wheel | 0.6 mg | 0.6 mg | 0.4 mg loss | 0.4 mg loss |
| 1000 gm-1000 cycle | loss | loss | | |
| ASTM D-4060 | | | | |
| Elcometer PSI | — | — | — | — |
| Concrete | 450 | 375 | 750 | 900 |
| Steel | >1000 | >1000 | >1300 | >1500 |
| ASTM 4551 | | | | |
| Moisture Vapor | <0.1 | <0.1 | <0.1 | <0.1 |
| Transmission (Perms) | | | | |
| ASTM E96-80 | | | | |
| Water Absorption | 1.90% | 2.20% | 1.25% | 0.85% |
| WT Gain | | | | |
| ASTM D570-95 | | | | |

Additional examples of silicone modified polyureas are given below. Comparative examples 25-26 are conventional ratios and compositions and do not include any polyol prepolymer. Examples 27-28 are examples of the present silicone modified polyurea and do include amounts of different combinations and ratios of the novel polyol prepolymer chain extenders. All amounts are represented by parts by weight.

### Comparative Examples 25-26 and Examples 27-28

TABLE 8

Examples

| | 25 | 26 | 27 | 28 |
|---|---|---|---|---|
| D2000 (Jeffamine) | 50 | 50 | 45 | 45 |
| T-5000 (Jeffamine) | 10 | 10 | 10 | — |
| Polyol prepolymer chain | — | — | 10 | 10 |
| extender of Example 7 | | | | |
| E100 (Ethacure) | 25 | 15 | 15 | 15 |
| 4200 (Unilink) | — | 10 | — | — |
| A-187 | 0.4 | 0.4 | 0.4 | 0.4 |
| 15.5% NCO Index | 105 | 105 | 105 | 105 |
| Gel Time (Sec) | 3.5 | 4.8 | 5.0 | 4.5 |
| Tack Free (Sec) | 5.5 | 7.5 | 7.5 | 6.5 |

### Physical Property Testing

Physical property testing for the silicone modified polyureas noted in Table 8 were done in accordance with American Society for Testing and Materials (ASTM). The ASTM test methods and their physical property test descriptions are given below in Table 9:

TABLE 9

| | Examples | | | |
|---|---|---|---|---|
| | 25 | 26 | 27 | 28 |
| Tensile Strength PSI | 2541 | 2430 | 2720 | 3610 |
| ASTM D-638 | | | | |
| % Elongation | 235 | 265 | 420 | 350 |
| ASTM D-638 | | | | |
| Tear Strength P.L.I. | 357 | 340 | 510 | 550 |
| ASTM D-624 | | | | |
| Shore Hardness D | 47/40 | 47/40 | 47/40 | 47/40 |
| ASTM D2240-81 | | | | |
| Abrasion HS-18 Wheel | 0.6 mg | 0.6 mg | 0.4 mg loss | 0.4 mg loss |
| 1000 gm-1000 cycle | loss | loss | | |
| ASTM D-4060 | | | | |
| Elcometer PSI | — | — | — | — |
| Concrete | 450 | 375 | 750 | 900 |
| Steel | >1000 | >1000 | >1300 | >1500 |
| ASTM 4551 | | | | |
| Moisture Vapor | <0.1 | <0.1 | <0.1 | <0.1 |
| Transmission | | | | |
| (Perms) | | | | |
| ASTM E96-80 | | | | |
| Water Absorption | 1.90% | 2.20% | 1.25% | 0.85% |
| WT Gain | | | | |
| ASTM D570-95 | | | | |

In another embodiment of the present invention, secondary polyether amines am reacted with a monomer stripped aliphatic isocyanate dimer to produce prepolymers from about 5% to about 18% isocyanate content. A diluent, such as caprolactone, is then added to the prepolymer to reduce viscosity and improve the UV stability when reacted with a primary amine. These prepolymers react with aromatic diamines to produce polyurea polymers with excellent properties. Also, when a UV package is added to the prepolymers and/or aromatic diamine, significant improvement in non-yellowing occurs.

Additional examples of prepolymers are given below.

### EXAMPLE 29

### Prepolymer from Primary Polyether Amines

A prepolymer made from primary polyether amines was prepared by placing 100 PBW of N-3400 (Bayer) in a mixing vessel. The mixing vessel is spun at approximately 1,000 RPM to create a vortex and then 80 PBW of D-2000 Jeffamine is added slowly to the vortex of the mixing vessel. It is noted that the viscosity increases almost instantly and gelation occurs on the shaft of the mixing vessel. This mixture produces a prepolymer with an NGO (isocyanate) content of approximately 9.5%.

### EXAMPLE 30

### Improved Prepolymer made from Secondary Diamine

A prepolymer made from a secondary diamine was prepared by placing 100 PBW of N-3400 (Bayer) in a mixing vessel. The mixing vessel is spun at approximately 1,000 RPM to create a vortex and then 80 PBW of Jeffamine 576, a secondary diamine made from a D-2000 Jeffamine, is added to the vortex of the mixing vessel. Conversely to Example 29, it is noted that the viscosity of the prepolymer made according to Example 30 did not increase almost instantly and gelation did not occur on the shaft of the mixing vessel. Further, it is noted that the Jeffamine 576 did not cause any viscosity or gelation problems even when added at a fast rate. This mixture produces a prepolymer with an NCO (isocyanate) content of approximately 9.5%.

### EXAMPLE 31

### Another Aromatic Prepolymer

A prepolymer was prepared with 50 PBW of the prepolymer of Example 29 and 10 PBW of DETDA E-100 Ethacure from Albemarle Corp. It was noted that gelation occurred at approximately 60 seconds during the mixing of these compounds. The product produced was cloudy, milky, or colored when casted.

### EXAMPLE 32

### Another Prepolymer

A prepolymer was prepared with 50 PBW of the prepolymer of Example 30 and 10 PBW of DETDA E-100 Ethacure from Albermarle Corp. It was noted that gelation occurred at approximately 60 seconds during the mixing of these compounds. The finished castings of this product were clear in color when compared to those of Example 29.

### EXAMPLE 33

### Another Aromatic Prepolymer

A prepolymer was prepared with 50 PBW of the prepolymer of Example 29, 10 PBW of DETDA E-100 Ethacure from Albemarle Corp, and 10 PBW of caprolactone. In addition, a UV package was added to the mixture that included 1% Tinivan 292 and 1% Tinivan 1130 from Ciba Speciality Chemicals. It was noted that gelation occurred at approximately 65 seconds during the mixing of these compounds. The product produced was cloudy, milky, or colored when casted; in addition, less air bubbles occurred in the casting.

### EXAMPLE 34

### Another Aromatic Prepolymer

A prepolymer was prepared with 50 PBW of the prepolymer of Example 30, 10 PBW of DETDA E-100 Ethacure from Albemarle Corp, and 10 PBW of caprolactone. In addition, a UV package was added to the mixture that included 1% Tinivan 292 and 1% Tinivan 1130 from Ciba Speciality Chemicals. It was noted that gelation occurred at approximately 65 seconds during the mixing of these compounds. The product produced was cloudy, milky, or colored when casted; in addition, less air bubbles occurred in the casting.

### EXAMPLE 35

### Prepolymer from Aliphatic Diamines

A prepolymer was prepared with 295 PBW of the prepolymer of Example 29 and 100 PBW of the aliphatic diamine Clearlink-™ 1000 from UOP. Gelation occurred at approximately 15 seconds during the mixing of these compounds. The mixture was too thick to pour for casting purposes.

### EXAMPLE 36

### Prepolymer from Aromatic Hexamine

A prepolymer was prepared with 488 PBW of the prepolymer of Example 30, 100 PBW of the aromatic hexamine ReactAmine® 100H from ReactAmine® Technology, and 10 PBW of caprolactone. In addition, a UV package was added to the mixture that included 1% Tinivan 292 and 1% Tinivan 1130 from Ciba Speciality Chemicals. Gelation occurred at approximately 65 seconds during the mixing of these compounds. The finished castings of this product were clear

### EXAMPLE 37

### Comparative Prior Art Aromatic Polyurea

For comparison purposes, it is known in to make a polyurea that includes an aromatic diamine prepolymer, such as E-300 from Albermarle Corp., made with MDI of polytetraamineglycol.

The compositions of Examples 31-37 and 12 were evaluated and are shown in Table 10.

TABLE 10

| Examples | UV Yellow Index in 8 Days |
|---|---|
| 31 | 27 |
| 32 | 18 |
| 33 | 25 |
| 34 | 13.7 |
| 35 | 12.7 |
| 36 | 13 |
| 37 | 50 |

The above UV results were achieved by placing cast samples of each product produced in Examples 29-36 in a UV chamber for 8 days. An A-bulb (360 nm) was used in the UV chamber. After the 8 day period, the samples were taken out of the UV chamber and examined.

From Examples 29-36 and Table 10, it can be seen that Examples 34 and 36 had approximately the same UV yellow index as Example 35, an aliphatic prepolymer. Although Example 35 has excellent UV properties for non-yellowing, it has very poor processing properties, poor heat resistance properties, and poor flexural modulas. Conversely, Examples 34 and 36 possessed excellent processing properties, excellent heat resistance properties, and excellent flexural modulas.

In another embodiment of the present invention, a secondary polyether amines is reacted with a monomer stripped aliphatic isocyanate dimer that is then added to an aromatic amine that are then added to an aromatic amine to produce the B-component of a polyurea. Typically, the aromatic amine has a low viscosity and it reacts exothermically with the monomer stripped aliphatic isocyanate dimer to cause the volatiles and impurities in the mixture to volatilize, thus producing a better polymer. The A-component includes a secondary polyether amine that is reacted with a monomer stripped aliphatic isocyanate dimmer. Then the B-component is added to the A-component to produce a polyurea having improved percent elongation, improved tear strength, decreased volatiles content, increased molecular weight, and improved non-yellowing characteristics. In addition, a diluent, such as caprolactone, may be added to the prepolymer to reduce viscosity and improve the UV stability when reacted with the amine. These prepolymers react with aromatic diamines to produce polyurea polymers with excellent properties. Also, when a UV package is added to the prepolymers and/or aromatic diamine, significant improvement in non-yellowing occurs.

Additional examples of prepolymers are given below.

### EXAMPLE 38

### Improved Modified Aliphatic Prepolymer

An improved modified aliphatic prepolymer made by placing 100 PBW of an aliphatic polyisocyanate, N-3400 (Bayer), in a mixing vessel. The mixing vessel is spun at approximately 1,000 RPM to create a vortex and then 200 PBW of Jeffamine 576, a secondary diamine polyetheramine made from a D2000 Jeffamine, is added to the vortex of the mixing vessel. This mixture produces a prepolymer with an NCO (isocyanate) content of approximately 6.5%. This constitutes one embodiment of the A-component of a modified polyurea of the present invention.

### EXAMPLE 39

### Improved Prepolymer made from Secondary Diamine

A prepolymer made from a secondary diamine was prepared by placing 100 PBW of N-3400 (Bayer) in a mixing vessel. The mixing vessel is spun at approximately 1,000 RPM to create a vortex and then 200 PBW of Jeffamine 576, a secondary diamine made from a D-2000 Jeffamine, is added to the vortex of the mixing vessel. This mixture produces a prepolymer with an NCO (isocyanate) content of approximately 6.5%. Then 100 PBW of this 6.5% NCO aliphatic isocyanate prepolymer mixture was mixed with 100 PBW of the DETDA E-100 Ethacure from Albermarle Corp. The 6.5% NCO aliphatic isocyanate prepolymer is slowly added to the DETDA E-100 under agitation. This reaction takes approximately 3 minutes to 15 minutes. Then the mixture is cooled. This constitutes one embodiment of the B-component of the modified polyurea of the present invention.

### EXAMPLE 40

### Improved Prepolymer made from Secondary Diamine

A prepolymer made from a secondary diamine was prepared by placing 100 PBW of N 3400 (Bayer) in a mixing vessel. The mixing vessel is spun at approximately 1,000 RPM to create a vortex and then 200 PBW of Jeffamine 576, a secondary diamine made from a D-2000 Jeffamine, is added to the vortex of the mixing vessel. This mixture produces a prepolymer with an NCO (isocyanate) content of approximately 6.5%. Then 10 PBW of this 6.5% NCO aliphatic isocyanate prepolymer mixture was mixed with 100 PBW of the DETDA E-100 Ethacure from Albemarle Corp. The 6.5% NCO aliphatic isocyanate prepolymer is slowly added to the DETDA E-100 under agitation. This reaction takes approximately 3 minutes to 15 minutes. Then the mixture is cooled. This constitutes another embodiment of the B-component of the modified polyurea of the present invention.

### EXAMPLE 41

### Improved Prepolymer made from Secondary Diamine

A prepolymer made from a secondary diamine was prepared by placing 100 PBW of N-3400 (Bayer) in a mixing vessel. The mixing vessel is spun at approximately 1,000 RPM to create a vortex and then 200 PBW of Jeffamine 576, a secondary diamine made from a D2000 Jeffamine, is added to the vortex of the mixing vessel. This mixture produces a prepolymer with an NCO (isocyanate) content of approximately 6.5%. Then 20 PBW of this 6.5% NCO aliphatic isocyanate prepolymer mixture was mixed with 100 PBW of the DETDA E-100 Ethacure from Albermarle Corp. The 6.5% NCO aliphatic isocyanate prepolymer is slowly added to the DETDA E-100 under agitation. This reaction takes approximately 3 minutes to 15 minutes. Then the minute is cooled. This consulates another embodiment of the B-component of the modified polyurea of the present invention.

### EXAMPLE 42

### Modified Polyurea

A modified polyurea was prepared by mixing 100 PBW of DETDA E-100 Ethacure from Albermarle Corp and 646 PBW of the prepolymer of Example 38. The product produced a polyurea that was cloudy, milky, or colored when casted; in addition, less air bubbles occurred in the casting.

### EXAMPLE 43

### Modified Polyurea

A modified polyurea was prepared by mixing 100 PBW of the prepolymer of Example 41 and 600 PBW of the prepolymer of Example 38. The product produced a polyurea that was cloudy, milky, or colored when casted; in addition, less air bubbles occurred in the casting.

The compositions of Examples 42-43 were evaluated and are shown in Table 11.

TABLE 11

Examples

| | 42 | 43 |
|---|---|---|
| Tensile Strength PSI | 5938 | 6345 |
| ASTM D-638 | | |
| UV Color | Yellow in | Yellow in |
| | 4 days | 14 days |
| Tear Strength P.L.I. | 589 | 678 |
| ASTM D-624 | | |

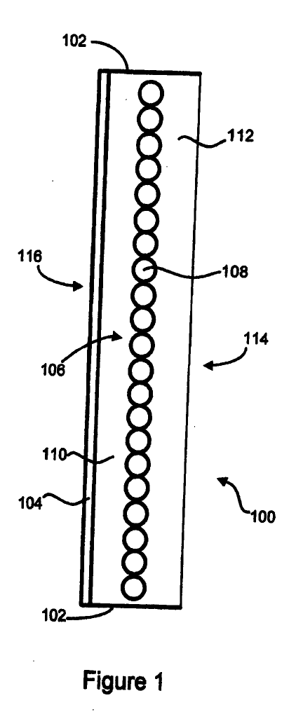

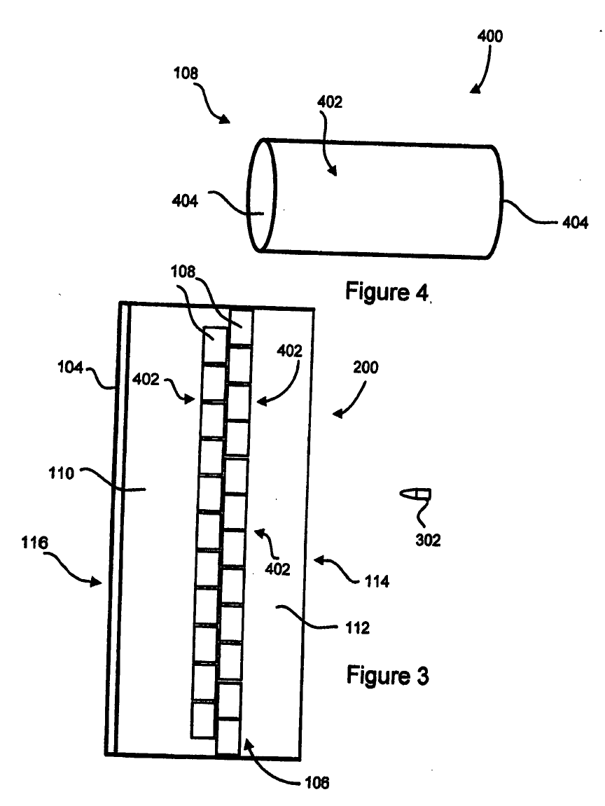

In one embodiment of the present invention, the silicone modified polyurea can be used to make a ballistic proof panel or material. For example, silicone carbide ceramic cylinders are used with the silicone modified polyurea to produce ballistic proof panels that prevent canon shells or armor piercing shells from piercing through the ballistic proof panels. In one embodiment, a silicone modified polyurea is molded on one side or both sides of a row of a rigid material to produce a ballistic-proof panel. FIG. 1 illustrates an embodiment 100 of a ballistic proof panel having a front 114 and a rear 116 comprising a row 106 of barrels 108 molded together with a silicone modified polyurea 112 and 110 as disclosed herein. Barrels 108 means generally a cylindrical machined or formed part having a size and shape as described herein. The barrels 108 may be a complete cylindrical machined part or any other forms of a barrel 108, such as a barrel 108 that is cut in half or quarters along its major axis. A projectile 302 (See FIG. 3) impacts the front 114 of the silicone modified polyurea 112 layer first and then impacts the row 106 of barrels 108 that stops the projectile 302 from exiting the ballistic proof panel 100.

Referring to FIG. 1, the ballistic proof panel 100 includes sides 102 and back 104 that together create a form for casting the ballistic proof panel 100. In one embodiment, the sides 102 and back 104 are part of a functioning ballistic proof panel 100. In another embodiment, they can be used to cast the ballistic proof panel 100 and then removed prior to its use. In one embodiment, a plurality of barrels 108 are placed side by side to create a row 106 of such pieces.

For those embodiments that incorporate a back 104 and sides 102, these structures comprise materials having particular strength properties while being lightweight. For example, back 104 and sides 102 can be made out of sheets of aluminum or other lightweight material. The thickness of the back 104 and sides 102 maybe any desired thickness to fit a particular design. In one embodiment, the thickness of the back 104 and sides 102 is ½″.

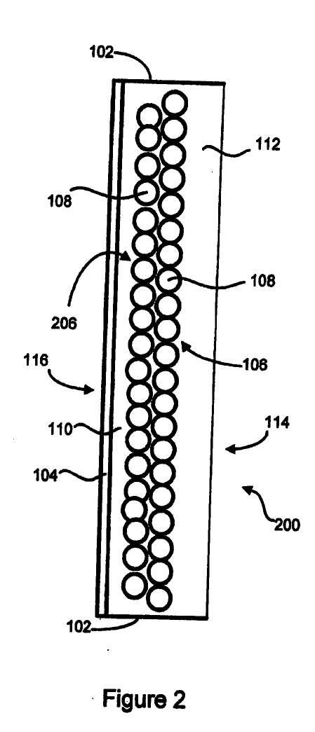

FIG. 2 depicts another embodiment 200 of a ballistic proof panel that includes the similarly numbered elements as described in FIG. 1 above. In addition to the row 106 of barrels 108, a row 206 of barrels 108 is located behind the first row 106. Preferably, each of the barrels 108 of row 206 is offset from the row 106 of barrels 108. As illustrated in FIG. 2, this offset is preferably created by staggering each one of the barrels 108 of the row 206 so that the center of each one of the barrels 108 of the row 206 is located directly or substantially directly behind the junction of the two pieces of barrels 108 located directly in front of it in row 106. In yet another embodiment, additional rows of the barrels 108 may be used as desired

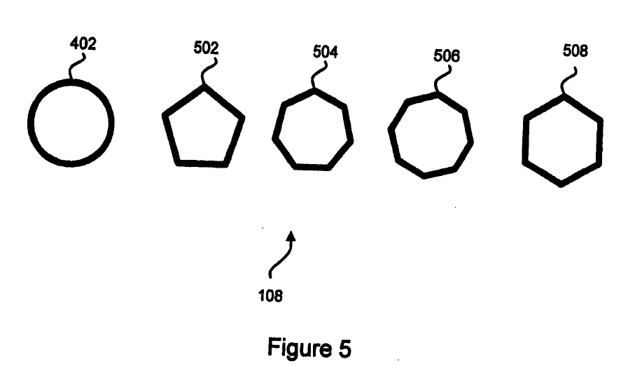

FIG. 3 illustrates a top view of the ballistic proof panel 200 depicting the rows 106 and 206 of barrels 108. As illustrated in FIG. 3, the sides 402 (See FIG. 4) of the barrels 108 have their ends 404 (See FIG. 4) substantially adjacent to or abutting each other. A projectile 302 is shown approaching the front 114 of ballistic proof panel 200.

Preferably, row 106 comprises a plane of rows of barrels 108 that extends in the plane to provide protection for the desired surface area. Similar , row 206 comprises a plane of rows of barrels 108 that extends in the plane to provide protection for the desired surface area. For example, in reviewing FIGS. 2 and 3, it can be seen that row 106 comprises several rows of barrels 108 adjacent to one another in a plane, similarly for row 206 as well.

It can be seen in FIGS. 1-3 that the rows 106 and 206 of the barrels 108 of the ballistic proof panels 100 and 200 have a silicone modified polyurea layer 112 located on the front 114 of the ballistic proof panels 100 and 200. It can be further be seen in FIGS. 1-3 that the rows 106 and 206 of the barrels 108 of the ballistic proof panels 100 and 200 have a silicone modified polyurea layer 110 located on the back 116 of the ballistic proof panels 100 and 200. Preferably the silicone modified polyurea layers 112 and 110 are comprised of the material as described in Examples 32,34, and 36.

The thickness of the silicone modified polyurea layers 110 and 112 may be any thickness to fit a desired use. Preferably, the thicknesses of the silicone modified polyurea layers 110 and 112 are between 1 inch and 3 inches. The width and height of the silicone modified polyurea layers 110 and 112 are any desired distance or length to accommodate a desired panel dimension. Thickness can vary with the type bullet you are stopping.

FIG. 4 illustrates an embodiment 400 of an individual barrel 108 having a cylindrical shape including ends 404 and side 402. In this embodiment, the cross-section of the barrel 108 is round as depicted in FIG. 5, thus providing an arcuate, curved, or angular side 402 to an incoming projectile 302. In other embodiments, barrels 108 can be from other rod stock type material having sides 402 that correspond to other cross-section shapes, such a pentagon 502, heptagon 504, octagon 506, and hexagon 508. Because of these cross-sections of the barrels 108 and their sides 402, the direction of the projectile 302 is redirected after it impacts the barrels 108, thus stopping the projectile within the ballistic proof panels 100 and 200. Thus, it can be seen that other barrels 108 that are capable of redirecting the direction of the projectile 302 may also be used. It is therefore preferred that the side 402 (See FIG. 4) of each of the barrels 108 be facing the projectile 302 for the ballistic proof panels 100 and 200.

The barrels 108 can be a rod stock material that is solid or hollow in the center and is composed of a material having strength to redirect the projectile 302 after it traveled through the silicone modified polyurea layer 112. In one embodiment, the barrels 108 is a hexalloy ceramic material. In another embodiment, the barrels 108 is a silicone carbide material. In another embodiment, the barrels 108 is a ceramic rod material that has an aluminum oxide content of preferably equal to or greater than 95%. In one embodiment, the barrels 108 is a ½″ diameter hexalloy ceramic material from Saint-Gobain, item number # 30586.

The barrels 108 has a diameter that is adequate to provide ballistic proof characteristics when used with the silicone modified polyurea. For example, the barrels 108 can have a diameter of between ⅛″ and 4″. In one embodiment, the barrels 108 has a diameter of ½″. In one embodiment, the length of each barrels 108 is determined by each desired application. In one embodiment, the barrels 108 is 1″ in length.

The ballistic proof panels 100 and 200 can be of any size desired for a particular application. For example, ballistic proof panels 100 and 200 may be of a size to fit a soldier or an armed vehicle, such as a tank or armored personnel carrier.

Several ballistic proof panels made in accordance with a silicone modified polyurea were tested. In one test, a ballistic proof panel was made with silicone modified polyureas 110 and 112 having a composition of Example 30 and having rows 106 and 206 of barrels 108 made from ½″ diameter silicon carbide ceramic rods from Saint Gobain. In another test, a ballistic proof panel was made with of silicone modified polyurea 110 and 112 comprising a composition of Example 31 and having rows 106 and 206 of barrels 108 made from ½″ diameter silicon carbide ceramic rods from Saint Gobain. In yet another test, a ballistic proof panel was made with of silicone modified polyurea 110 and 112 comprising a composition of Example 36 and having rows 106 and 206 of barrels 108 made from ½″ diameter silicon carbide ceramic rods from Saint Gobain. For all three ballistic proof panels, a 20 mm canon shell having an initial velocity of 300 ft/sec fired at a ballistic panel 60 ft away did not penetrate through the ballistic proof panels made with the silicone modified polyurea made in accordance with the present invention. In addition, for all three ballistic proof panels, a 762-63-AP armor piercing shell fired at a ballistic panel 60 ft away did not penetrate through the ballistic proof panels made with the silicone modified polyurea made in accordance with the present invention.

In yet another embodiment, the present invention also includes methods for applying the silicon modified polyurea to surfaces for adding additional ballistic proof properties to the surface. The application may be done via a spray type application or other type of application. The silicone modified polyureas described herein may be applied in a spray application to armored vehicles to provide additional ballistic proof properties to the vehicle.

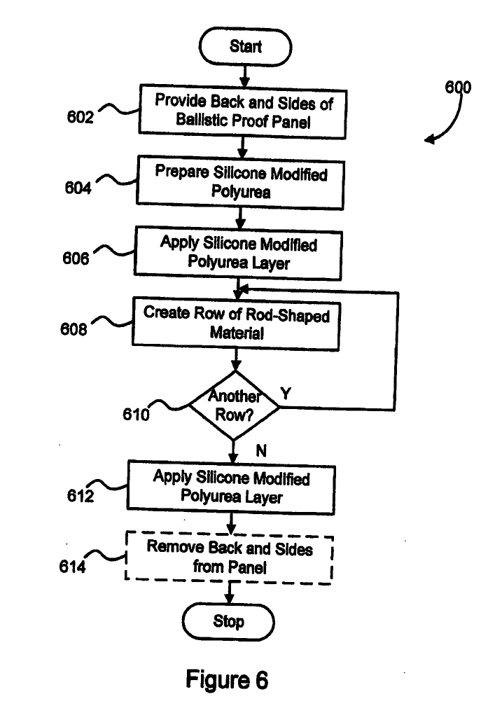

FIG. 6 illustrates an embodiment 600 of a flow diagram for making the ballistic proof panels 100 and 200 with the back 104 and sides 102 incorporated. In step 602, a back 104 and sides 102 are provided to create a form for applying a layer of silicone modified polyurea 110. In one embodiment, the back 104 and sides 102 are made from sheet aluminum. In one embodiment, any methods may be used for joining the back 104 to the sides 102. In another embodiment, the back 104 and sides 102 are stamped out of a single piece of sheet of light weight material such as aluminum. In step 604, a silicone modified polyurea composition is prepared for applying in step 606 into the ballistic proof panel. In step 608, a row 106 of barrels 108 is placed inside of the back 104 and sides 102 adjacent to the applied layer of silicone modified polyurea 110. In step 610, additional rows 206 of barrels 108 is placed inside of the back 104 and sides 102 adjacent to the row 106 of barrels 108. In step 712, a layer of silicone modified polymer 112 is applied over the row 106 and/or row 206 of barrels 108. In optional step 614, the back 104 and sides 102 are removed from the cast ballistic proof panels 100 and 200.

### Spray Application

In one aspect of the present invention, a method is included for applying the present invention silicone modified polyurea to a substrate, and more specifically, applying to concrete or steel.

For preparation of old concrete prior to application, sandblasting, shot blasting, or water blasting is highly preferable to remove any surface contaminates. Any oils or fats should be removed prior to application of the silicone modified polyurea. Acid etching may be required (followed by a thorough rinsing) to open the pores of the concrete to accept a primer coat. A primer may be applied, such as Reactamine® Primer from Reactamine Technologies, LLC, to further improve the bonding of the silicone modified polyurea to the concrete. A minimum 40-mil coating is generally preferable for improved chemical and abrasion resistance.

For preparation of new concrete, the concrete should cure for preferably a minimum of 30 days. Also preferably, sand blasting, shot blasting, or acid etching (15% muriatic acid/85% water) is required to remove the surface lattice that appeared during the curing process. Again, a primer, such as Reactamine® Primer, is preferably applied to reduce out gassing of the concrete.

For preparation of steel, the steel must be prepared to a “near white metal” equivalent to SSPC 10 or NACE 2 standards. For immersion service, a 3-mil blast profile is preferable. A 2-mil blast profile is generally recommended. A 10-40 mil coat of Reactamine® Primer is generally preferable for improved chemical resistance performance.

In one aspect, the present invention includes the following spray application. A substrate (concrete, steel etc.) is preferably prepared as described herein. In one aspect, the B-component is contained in one container and the A-component is contained in another. Into each of these two containers is placed a displacement pump connected to a hose. The respective displacement pump pumps the respective component stored in that container through the respective hose to a separate volumetric cylinder-type measurement devices, which accurately measures the exact amounts of the A-component and B-component. The A-component is measured in one volumetric cylinder-type measurement device and the B-component is measured in another. Preferably, each cylinder measures equal Each volumetric cylinder-type measurement device is then pressurized in the range from 500 psi to 3000 psi. The A-component and the B-component are then separately pumped through a heater which heats each component separately to temperatures from about 50° F. to 250° F. The separated individual components are then pumped through one heated hose for each component and sent to an impingement spray gun.

For example, the present invention silicone modified polyurea is preferably applied to the substrate using a high pressure plural component pump (1:1 by volume), such as a GlasCraft-MX® equipped with a Prober® impingement mix spray gun or a Gusmer® H-20/35 proportioning unit and a Gusmer® GX-7 (400 Series) or GX-8 impingement mix spray gun. As described above, each proportioning unit is preferably capable of supplying the correct pressure and heat for the required hose length on a consistent basis. In addition, the hose is preferably heated to keep the reactants at a temperature of at least 150° F. Preferably, for processing, the block temperature of the heater was set at 160° F. for both the B-component and the A-component and the hose temperature was set at 160° F. for both components. Processing was at 2500 psig static pressure and 2000 psig spray pressure.

There has been described a novel polyol prepolymer chain extender and silicone modified polyurea that can be aliphatic or aromatic. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, the polyol prepolymer chain extenders that are described can be used as chain extenders for other types of reactions to produce attics, epoxies, and other materials. It is also evident that the process steps recited may in some instances be performed in a different order, or equivalent structures and processes may be substituted for the various structure and processes described. The structures and processes may be combined with a wide variety of other structures and processes.

GLOSSARY

| | |
|---|---|
| ETHACURE ® 100 | Diethyltoluene diamine chain extender available from |
| | Albemarle ™ Corporation. |
| JEFFAMINE ® D-2000 | A 2000 molecular weight polyoxypropylene diamine available |
| | from Huntsman Petrochemical Corporation. |
| JEFFAMINE ® T-5000 | A 5000 molecular weight polyoxypropylene triamine available |
| | from Huntsman Petrochemical Corporation. |
| SILQUEST ® A-187 | Functional alkoxy silane available from OSi Specialties, |
| | Inc./Crompton Corp. |
| UNILINK ® 4200 | Dialkyl substituted methylene dianiline chain extender available |
| | from UOP Chemical Co. |
| Tinuvin ® 328 | UV stabilizer available from Ciba-Geigy Corp. |
| Tinuvin ® 765 | UV stabilizer available from Ciba-Geigy Corp. |
| Ti-Pure ® R-900 | Rutile titanium dioxide available from E.I. DuPont de Nemours |
| | Co. |
| Silquest ® A-1100 | Gamma-aminopropyltriethoxysilane is an amino-functional |
| | coupling agent from OSi Specialties, Inc./Crompton Corp. |
| MDI 1680 | 4,4-Diphenylisocyanate from Huntsman Petrochemical Corp. |
| N-3400 | 1,6-Hexamethylenediisocanate. |
| CoatOSil ® 2810 | Epoxy silicone copolymers similar to HP 1000. |
| OSi 2812 | 2000 mwt silicone endcapped diol. |
| NH1220 and NH1420 | Polyaspartic esters from Bayer. |
| AFL-5 and AFL-10 | Aminofunctional poly-dimethylsiloxanes |
| IPDI | Isophorone di-isocyanate |
| HDI | Hexamethyl di-isocyanate |
| TMXDI | Tetramethyl xylene di-isocyante |
| Rubinate ® 9484 MDI | Methylene diphenyl isocyanate from Huntsman Petrochemical |
| | Corp. |

What is claimed:

1. A modified aliphatic prepolymer A-component for a polyurea comprising:
at least one polyetheramine; and
at least one aliphatic polyisocyanate.

2. The modified aliphatic prepolymer of claim 1 wherein said at least one polyetheramine is a secondary diamine.

3. The modified aliphatic prepolymer A-component of claim 1 wherein said at least one polyetheramine is present in the range of from about 25 to about 80 parts by weight, based on 100 parts by weight of the total modified aliphatic prepolymer A-component.

4. The modified aliphatic prepolymer A-component of claim 1 wherein said at least one aliphatic isocyanate is present in the range of from about 12 to about 40 parts by weight, based on 100 parts by weight of the total modified aliphatic prepolymer A-component.

5. The modified aliphatic prepolymer A-component of claim 1 wherein the NCO content of said of at least one aliphatic polyisocyanate is from about 2.5% to about 105% by weight based on the total weight of the modified aliphatic prepolymer A-component.

6. The modified aliphatic prepolymer A-component of claim 1 wherein the NCO content of said at least one aliphatic polyisocyanate is 6.5% by weight based on the total weight of the modified aliphatic prepolymer A-component.

7. A modified aliphatic prepolymer B-component for a polyurea comprising:
a modified aliphatic prepolymer including at least one polyetheramine and at least one aliphatic polyisocyanate;
an aromatic amine.

8. The modified aliphatic prepolymer B-component of claim 7 wherein said modified aliphatic prepolymer has an NCO content of from about 2.5% to about 10.5% by weight based on the total weight of said modified aliphatic prepolymer.

9. The modified aliphatic prepolymer B-component of claim 7 wherein said modified aliphatic prepolymer has an NCO content 6.5% by weight based on the total weight of said modified aliphatic prepolymer.

10. The modified aliphatic prepolymer B-component of claim 7 wherein said modified aliphatic prepolymer is present from about 1% to about 20% parts by weight based on the total weight of the total modified aliphatic B-component.

11. The modified aliphatic prepolymer B-component of claim 7 wherein said modified aliphatic prepolymer is 10% parts by weight based on the total weight of the total modified aliphatic B-component.

12. A modified polyurea comprising:
a B-component which includes at least one polyol prepolymer chain extender which comprises:
a modified aliphatic prepolymer including at least one polyetheramine and at least one aliphatic polyisocyanate;
an aromatic amine;
an A-component which comprises:
at least one polyetheramine; and
at least one aliphatic polyisocyanate.

13. The modified polyurea of claim 12 wherein said at least one polyetheramine is a secondary diamine.

14. The modified polyurea of claim 12 wherein said at least one polyetheramine is present in the range of from about 25 to about 80 parts by weight, based on 100 parts by weight of the total modified aliphatic prepolymer A-component.

15. The modified polyurea of claim 12 wherein said at least one aliphatic isocyanate is present in the range of from about 12 to about 40 parts by weight, based on 100 parts by weight of the total modified aliphatic prepolymer A-component.

16. The modified polyurea of claim 12 wherein the NCO content of said at least one aliphatic polyisocyanate is from about 2.5% to about 10.5% by weight based on the total weight of the modified aliphatic prepolymer A-component.

17. The modified polyurea of claim 12 wherein the NCO content of said at least one aliphatic polyisocyaate is 6.5% by weight based on the total weight of the modified aliphatic prepolymer A-component.

18. The modified polyurea of claim 12 wherein said modified aliphatic prepolymer is present from about 1% to about 20% parts by weight based on the total weight of the total modified aliphatic B-component.

19. The modified polyurea of claim 12 wherein said modified aliphatic prepolymer is 10% parts by weight based on the total weight of the total modified aliphatic B-component.

20. A ballistic protection panel comprising:
a first polyurea layer defining a plane comprising:
a B-component which includes at least one polyol prepolymer chain extender which comprises:
a modified aliphatic prepolymer including at least one polyetheramine and at least one aliphatic polyisocyanate;
an aromatic amine;
an A-component which comprises:
at least one polyetheramine; and
at least one aliphatic polyisocyanate;
a second polyurea layer substantially parallel to said plane of said first silicone modified polyurea layer comprising:
a B-component which includes at least one polyol prepolymer chain extender which comprises:
a modified aliphatic prepolymer including at least one polyetheramine and at least one aliphatic polyisocyanate;
an aromatic amine;
an A-component which comprises:
at least one polyetheramine; and
at least one aliphatic polyisocyanate; and
a first layer of a plurality barrels interposed between said first polyurea layer and said second polyurea layer, said barrels having a substantially curved side substantially adjacent to said first silicone modified polyurea layer and said second polyurea layer.

21. The ballistic protection panel of claim 20 wherein said plurality of barrels have a cross-section shape selected from the group consisting of a cylinder, a pentagon, a heptagon, a octagon, and a hexagon.

22. The ballistic protection panel of claim 20 wherein said first polyurea layer and said second polyurea layer have a thickness of about ⅛″ to about 4″.

23. The ballistic protection panel of claim 20 further comprising:
a second layer of a plural of substantially rod-shaped pieces interposed between either said first silicone layer and said first layer of a plurality of barrels or between said second polyurea layer and said first layer of a plurality of barrels, said second layer of plurality of barrels having a substantially curved side substantially adjacent to either said first polyurea layer or said second polyurea layer.

24. The ballistic protection panel of claim 20 wherein said first layer of a plurality of barrels comprises a metal alloy.

25. The ballistic protection panel of claim 20 where said second layer of a plurality of barrels comprises a metal alloy.

26. The ballistic protection panel of claim 20 wherein said first layer of a plurality of barrels is selected from the group consisting of silicone carbide and a ceramic having an aluminum oxide content of equal to or greater than 95%.

27. A method for making a modified polyurea comprising:
mixing an aliphatic polyisocyanate with a secondary diamine polyetheramine to produce a modified aliphatic prepolymer A-component of said modified polyurea;
adding a portion of said modified aliphatic prepolymer A-component to an aromatic amine to produce a B-component of said modified polyurea; and
mixing said A-component to said B-component to produce said modified polyurea.

28. The method of claim 27 further comprising:
cooling said B-component prior to mixing with said A-component.
